(19) United States
(12) Patent Application Publication
(10) Pub. No.: US 2026/0061883 A1
(43) Pub. Date: Mar. 5, 2026

(54) ELECTRIC VEHICLE TO ELECTRIC VEHICLE CHARGING SYSTEM

(71) Applicant: EV Buddy, Inc., Edison, NJ (US)

(72) Inventors: Suresh Arya, Edison, NJ (US); Neal Gran, Hamden, CT (US)

(73) Assignee: EV Buddy, Inc., Edison, NJ (US)

(21) Appl. No.: 19/313,297

(22) Filed: Aug. 28, 2025

Related U.S. Application Data
(60) Provisional application No. 63/689,234, filed on Aug. 30, 2024.

(51) Int. Cl. B60L 53/68; B60L 53/10; B60L 53/30; B60L 53/62; B60L 55/00; H02J 7/34

(52) U.S. Cl. CPC B60L 53/68; B60L 53/11; B60L 53/305; B60L 53/62; B60L 55/00; H02J 7/342; B60L 2240/545; B60L 2240/547

(57) ABSTRACT

An Electric Vehicle (EV) to EV DC charging system may include coupling a source EV to a destination EV by coupling the source EV to an Electric Vehicle Supply Equipment (EVSE) charger, coupling the EVSE charger to a controller circuit, coupling the controller circuit to an EVSE DC fast charger, and coupling the EVSE DC fast charger to the destination EV, where the controller circuit establishes and maintains a communication link between the source EV and the destination EV. A stored energy transfer is initiated and controlled by processing circuitry coupled to an HMI and the controller circuitry. The EVSE DC fast charger may adjust input voltage according to the requirements of the destination EV. The processing circuitry tracks the progress of the stored energy transfer while the controller circuit monitors safety levels at the source EV and the destination EV.

### CROSS-REFERENCE TO RELATED APPLICATIONS

This application claims the benefit of U.S. Application 63/689,234, filed on Aug. 30, 2024, the contents of which are incorporated by reference herein.

### FIELD

In some example embodiments, the subject matter herein generally relates to electric vehicle charging and a more specifically to the transfer of stored energy between electric vehicles.

### BACKGROUND

Electric Vehicles (EVs), which include passenger automobiles, Sport Utility Vehicles (SUVs), trucks and the like, continue to increase in popularity, and the number of conventional passenger automobiles, SUVs, and trucks being replaced by EVs continues to grow. Unlike conventional automobiles, SUVs and trucks, that are powered by internal combustion engines, EVs, are powered by energy storage systems such as a battery pack or high-voltage Direct Current (DC) traction battery pack. The battery pack is coupled to an electric machine that creates power to propel or drive the vehicle. The battery, battery pack or traction battery pack may be recharged at a high-voltage DC charging station or alternatively via an Alternating Current (AC) power source including a home AC power outlet.

Technological advancements in battery technology have extended the milage range of EVs with some EV having a range as high as 520 miles (836.9 km) before requiring a recharge. The range, however, can be as low as 29 miles (46.7 km) in some EVs. While EVs are typically configured with a charge level indicator and range indicator, an operator of an EV may have to plan, in advance, where to recharge the EV according to the distance between a starting location and a destination location. The number of EV charging stations continues to grow, but the numbers are not yet comparable to conventional fuel stations, and just like conventional passenger automobiles, SUVs and trucks, that run low on conventional fuel, EV operators may find themselves stranded or unable to reach a charging location due to a low charge state of the EV.

Thus, the need exists for a technological solution of improved EV to EV stored energy transfer process, which may be referred to as EV to EV charging.

The description provided in the background section should not be assumed to be prior art merely because it is mentioned in or associated with the background section. The background section may include information that describes one or more aspects of the subject technology.

### SUMMARY

A system of one or more computers or processing circuitry may be configured to perform particular operations or actions by virtue of having software, firmware, hardware, or a combination of them installed on the system that in operation causes or cause the system to perform the actions. One or more computer programs or sets of instructions can be configured to perform particular operations or actions by virtue of including instructions that, when executed by processing circuitry, cause the processing circuitry to perform the actions.

In one general aspect, a method may include coupling an Electric Vehicle Supply Equipment (EVSE) charger to a source EV, and coupling the EVSE charger to a controller circuit. The method may furthermore include coupling the controller circuit to an EVSE DC fast charger, and coupling the EVSE DC fast charger to a destination EV, where the controller circuit establishes and maintains a communication link between the source EV and the destination EV. The method may moreover include monitoring, by the controller circuit, a state of the source EV and the destination EV through the communication link. The method may also include transferring stored energy from the source EV to the EVSE charger, and transferring stored energy from the EVSE charger to the destination EV by passing the stored energy through the controller circuit and the EVSE DC fast charger. The method may in addition include monitoring, by the controller circuit, predetermined safety levels at the source EV and the destination EV. The method may include maintaining stored energy transfer from the source EV to the destination EV while the predetermined safety levels are maintained. The method may also include adjusting, by the EVSE DC fast charger, input voltage according to requirements of the destination EV. The method may furthermore include controlling the stored energy transfer by a computer circuit, where the computer circuit tracks the stored energy transfer and communicates stored energy transfer progress information to a Human Machine Interface (HMI). Other embodiments of this aspect include corresponding computer systems, apparatus, and computer programs recorded on one or more computer storage devices, each configured to perform the actions of the methods.

Implementations may include one or more of the following features. The method may include displaying on the HMI an operator interface, and entering at least one of an amount of stored energy to be transferred from the source EV to the destination EV and a rate of transfer of the stored energy. The method may include monitoring continuously, by the controller circuit, battery temperatures, voltage and isolation conditions, and terminating the stored energy transfer between the source EV and the destination EV if a range of monitored conditions including the battery temperatures, the voltage and the isolation conditions exceed a predetermined value.

In another general aspect, an EV to EV DC charging system is disclosed. The EV to EV DC charging system may include an Electric Vehicle Supply Equipment (EVSE) charger, a source EV coupled to the EVSE charger, a controller circuit coupled to the EVSE charger, an EVSE DC fast charger coupled to the controller circuit, and a destination EV coupled to the EVSE DC fast charger. The controller circuit may be configured to establish and maintain a communication link between the source EV and the destination EV, and to monitor predetermined safety levels at the source EV and the destination EV. The system may include a Human Machine Interface (HMI), and a computer circuit coupled to the HMI and the controller circuit, where the HMI is configured to receive an operator input to establish connections between the source EV and the destination EV, and the computer circuit is configured to initiate a stored energy transfer from the source EV to the destination EV according to the operator input by passing the stored energy through the EVSE charger to the controller circuit, passing the stored energy from the controller circuit to the EVSE DC fast charger, and passing the stored energy from the EVSE DC fast charger to the destination EV. The system may in addition include the EVSE DC fast charger configured to adjust input voltage according to requirements of the destination EV. The computer circuit may be configured: to control the stored energy transfer between the source EV and the destination EV, track the stored energy transfer, and communicate progress information of the stored energy transfer to the HMI.

Implementations may include one or more of the following features. The EV to EV DC charging system where the HMI is configured to receive one or more operator inputs including an amount of stored energy to be transferred from the source EV to the destination EV and a charge rate corresponding to a rate of transfer of the stored energy. The controller circuit may be further configured to: continuously monitor battery temperatures, voltage and isolation conditions; and terminate the stored energy transfer between the source EV and the destination EV if a range of monitored conditions including the battery temperatures, the voltage and the isolation conditions exceed a predetermined value. Implementations of the described techniques may include hardware, a method or process, or a computer tangible medium.

### BRIEF DESCRIPTION OF THE DRAWINGS

FIG. 1 is a block diagram of an example EV to EV DC charging system.

FIG. 2 is a block diagram of another example EV to EV DC charging system.

### DETAILED DESCRIPTION OF THE PREFERRED EMBODIMENTS

The description of illustrative embodiments according to principles of the present disclosure is intended to be read in connection with the accompanying drawings, which are to be considered part of the entire written description. In the description of embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the disclosure expressly should not be limited to such exemplary embodiments illustrating some possible non-limiting combination of features that may exist alone or in other combinations of features; the scope of the disclosed techniques, apparatus, and system being defined by the claims appended hereto.

This description is not intended to be understood in a limiting sense, but provides an example of the technological solution presented solely for illustrative purposes by reference to the accompanying drawings to advise one of ordinary skill in the art of the advantages and construction of the technological solution. In the various views of the drawings, like reference characters designate like or similar parts.

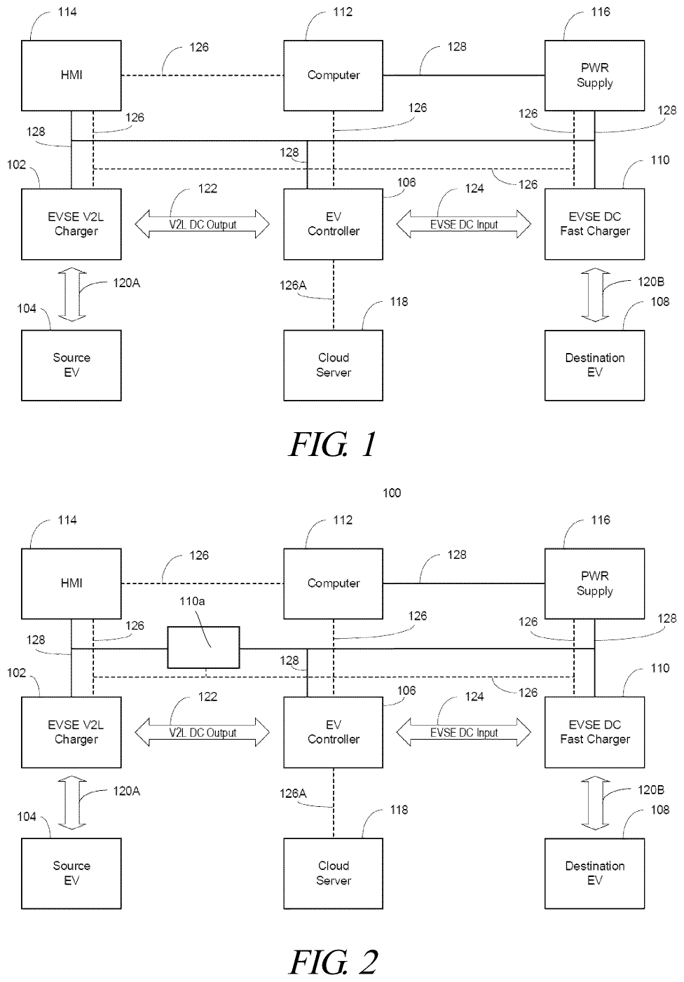

FIG. 1 is a block diagram of an EV to EV DC charging system 100. The EV to EV DC charging system includes an Electric Vehicle Supply Equipment (EVSE) charger. In some embodiments, the EVSE charger may include an EVSE Vehicle to Load (V2L) charger 102. EVSE V2L charger 102 may be an ISO 15118-20 compliant EVSE V2L charger. In some embodiments, the EVSE charger may function as an EVSE Vehicle to Grid (V2G) charger in addition to or instead of the EVSE V2L charger. EVSE V2L charger 102 is coupled with a source EV 104 via charge cable 120A. Charge cable 120A may include a standard Combined Charging System (CCS) or a North American Charging Standard (NACS) connector. A charge in the form of stored energy may be passed from the source EV 104 by the EVSE V2L charger 102.

EVSE V2L charger 102 may be coupled with an EV controller or controller processing circuitry 106. EVSE V2L charger 102 includes communication interface 126 coupled with EV controller 106. A charge in the form of stored energy may be passed from EVSE V2L charger 102 to EV controller 106 via V2L DC output 122. EVSE V2L charger 102 may be a vehicle to load or bidirectional standard use charger. EV controller 106 conducts continuous communication with source EV 104 and a destination EV 108 via communication interface 126. EV controller 106 may include a communication interface 126 coupled with rechargeable power supply 116. EV controller 106 may monitor the state of source EV 104 and destination EV 108 via communication interface 126. EV controller 106 may be configured with one or more sensors including, but not limited to, one or more voltage sensors, current sensors, and temperature sensors.

EV controller 106 may allow a charge process (transfer of stored energy) between source EV 104 and destination EV 108 to continue as long as both source EV 104 and destination EV 108 maintain proper safety levels. The safety levels may be predetermined values. EV controller 106 may continuously monitor certain conditions including battery temperature, voltage and isolation conditions. The controller may terminate the charge process if any of the monitored conditions exceed a predetermined range of values.

EV controller 106 may be coupled with rechargeable power supply 116 via interface 128. In an example embodiment, EV controller 106 may be powered a 12 volt car battery via cigarette lighter, automotive power socket or the like. In an embodiment, EV controller 106 may be powered via a USB port. In addition, in an example embodiment EV controller 106 may be power via the source EV 104 as it may switch to use the high voltage DC via a DC to DC converter to reduce the voltage to a voltage required to power the EV controller 106.

EV controller 106 may include a communication interface 126 coupled with EVSE DC fast charger 110, and EV controller 106 may be coupled with EVSE DC fast charger 110 and pass the charge in the form of stored energy to EVSE DC fast charger 110 via EVSE DC input 124. EVSE DC fast charger 110 may be an ISO 15118-20 compliant standard DC fast charger. EVSE DC fast charger 110 is coupled with destination EV 108 and passes the charge to destination EV 108 via charge cable 120B. Charge cable 120B may include a standard Combined Charging System (CCS) or a North American Charging Standard (NACS) connector. EVSE DC fast charger 110 may be configured to adjust the EVSE DC input 124 voltage according to the needs or requirements of the destination EV 108. EV controller 106 may be coupled with EVSE V2L charger 102 and EVSE DC fast charger 110 via communication interface 126.

As shown in FIG. 2, in some embodiments, a DC-DC converter 110a may be provided to adjust at least one of an output voltage, an output current, and an output power from EVSE V2L charger 102 according to a request from destination EV 108. The configuration of DC-DC converter 110a is not limited to the example illustrated in FIG. 2. In some embodiments, the DC-DC converter 110a may be integrated within EVSE V2L charger 102, or EVSE DC fast charger 110, or alternatively provided as a separate, optional unit. In some embodiments, control of DC-DC converter 110a may be performed by EVSE V2L charger 102, EVSE DC fast charger 110, or by an external computer system.

With reference to FIG. 1, the EV to EV DC charging system may include a computer or processing circuitry 112 which may be coupled with an HMI 114 via communication interface 126, coupled with a rechargeable power supply 116 via interface 128, and coupled with EV controller 106 via communication interface 126. EVSE V2L charger 102 and EVSE DC charger are coupled with power supply 116 via interface 128.

A charge process (transfer of stored energy from source EV 104 to destination EV 108) may be controlled by computer 112. Computer 112 may track the progress of the transfer of stored energy from the source EV 104 to the destination EV 108 and display the progress to an operator via HMI 114.

An operator may interface with computer 112 via HMI 114 through communication interface 126. The connection status between source EV and destination EV 108 may be displayed via HMI 114, and the operator may be prompted to make connections. HMI 114 includes a communication interface 126 coupled with EVSE V2L charger 102.

The initial charge and voltage condition and the state of the source EV 104 and destination EV 108 may be displayed via HMI 114. An operator, via HMI 114, may enter the amount of charge to be transferred from the source EV 104 to the destination EV 108 and initiate the charging process. In addition, the operator may enter the rate of transfer from the source EV 104 to the destination EV 108 via HMI 114. The operator may have an emergency shutoff option if it is deemed necessary to stop the charging process at any point. In addition, EV controller 106 may be configured to automatically terminate the charging process according to monitored safety levels. The emergency shutoff may be performed via a digital switch that may be activated according to an operator input or one or more sensors of EV controller 106. In an embodiment, the system may also be configured with a mechanical isolation or cutoff switch. Mechanical isolation cutoff may be performed with relay or contractors to open or close a power circuit. The power circuit may be a low or high power circuit.

The amount of charge to be transferred from source EV 104 to destination EV 108 and the rate of charge (rate of transfer) may be preset, where the preset amount of charge is an amount required for the destination EV 108 to reach a location where the destination EV 108 may be recharged. The rate of charge may determine the amount of time required to transfer the charge amount from the EV 104 to destination EV 108. At least one of the preset amount of charge and the rate of charge may be displayed to an operator via HMI 114. In an embodiment, an operator may input at least one of the preset amount of charge and the rate of charge via the HMI 114.

EV controller 106 may be coupled with cloud server 118 via communication interface 126A. Data may be recorded to a log file by EV controller 106 during the charge process. Session data from the charge process may be stored on cloud server 118, and session history for the system may be available. Communication interface 126A may be a wired or wireless interface. As a nonlimiting example, a wireless interface may be a Bluetooth, WiFi, LTE, 4G, or 5G wireless interface.

The EV to EV DC charging system may by configured to operate on pay-per-use basis or a subscription basis. Billing or payment may be performed via Open Charge Point Protocol (OCPP) or compatible payment processing application.

Other variations to the disclosed embodiments can be understood and effected by those skilled in the art in practicing the recited features, from a study of the drawings, the disclosure, and the appended claims.

In the claims, the word “comprising” does not exclude other elements or steps, and the indefinite article “a”or “an”does not exclude a plurality.

A single processor, device or other unit may fulfill the functions of several items recited in the claims. The mere fact that certain measures are recited in mutually different dependent claims does not indicate that a combination of these measures cannot be used to advantage.

Operations like acquiring, accessing, analyzing, capturing, comparing, determining, inputting, obtaining, outputting, providing, store or storing, calculating, simulating, receiving, warning, and stopping can be implemented as program code means of a computer program and/or as dedicated hardware.

A computer program may be stored and/or distributed on a suitable medium, such as an optical storage medium or a solid-state medium, supplied together with or as part of other hardware, but may also be distributed in other forms, such as via the Internet or other wired or wireless telecommunication systems.

What is claimed is:

1. A method of Electric Vehicle (EV) to EV Direct Current (DC) charging, the method comprising:
coupling an Electric Vehicle Supply Equipment (EVSE) charger to a source EV;
coupling the EVSE charger to a controller circuit;
coupling the controller circuit to an EVSE DC fast charger;
coupling the EVSE DC fast charger to a destination EV, wherein the controller circuit establishes and maintains a communication link between the source EV and the destination EV;
monitoring, by the controller circuit, a state of the source EV and the destination EV through the communication link;
transferring stored energy from the source EV to the EVSE charger;
transferring stored energy from the EVSE charger to the destination EV by passing the stored energy through the controller circuit and the EVSE DC fast charger;
monitoring, by the controller circuit, predetermined safety levels at the source EV and the destination EV;
maintaining stored energy transfer from the source EV to the destination EV while the predetermined safety levels are maintained;
adjusting, by the EVSE DC fast charger, input voltage according to requirements of the destination EV; and
controlling the stored energy transfer by a computer circuit, wherein the computer circuit tracks the stored energy transfer and communicates stored energy transfer progress information to a Human Machine Interface (HMI).

2. The method according to claim 1 further comprising:
displaying, on the HMI, an operator interface; and
entering at least one of an amount of stored energy to be transferred from the source EV to the destination EV and a rate of transfer of the stored energy.

3. The method according to claim 1, further comprising:
monitoring continuously, by the controller circuit, battery temperatures, voltage and isolation conditions; and
terminating the stored energy transfer between the source EV and the destination EV if a range of monitored conditions including the battery temperatures, the voltage and the isolation conditions exceed a predetermined value.

4. The method of claim 1, wherein the EVSE charger functions as at least one of an EVSE Vehicle to Load (V2L) charger, and an EVSE Vehicle to Grid (V2G) charger.

5. The method of claim 1, further comprising adjusting, by a DC-DC converter, at least one of an output voltage, an output current, and an output power from the EVSE charger according to a request from the destination EV.

6. An Electric Vehicle (EV) to EV Direct Current (DC) charging system comprising:
an Electric Vehicle Supply Equipment (EVSE) charger
a source EV coupled to the EVSE charger;
a controller circuit coupled to the EVSE charger;
an EVSE DC fast charger coupled to the controller circuit;
a destination EV coupled to the EVSE DC fast charger, wherein the controller circuit establishes and maintains a communication link between the source EV and the destination EV, and wherein the controller circuit is configured to monitor predetermined safety levels at the source EV and the destination EV;
a Human Machine Interface (HMI); and
a computer circuit coupled to the HMI and the controller circuit, wherein the HMI is configured to receive an operator input to establish connections between the source EV and the destination EV, and wherein the computer circuit is configured to initiate a stored energy transfer from the source EV to the destination EV according to the operator input by passing the stored energy through the EVSE charger to the controller circuit, passing the stored energy from the controller circuit to the EVSE DC fast charger, and passing the stored energy from the EVSE DC fast charger to the destination EV;
the EVSE DC fast charger configured to adjust input voltage according to requirements of the destination EV; and
the computer circuit configured:
to control the stored energy transfer between the source EV and the destination EV,
track the stored energy transfer;
and communicate progress information of the stored energy transfer to the HMI.

7. The EV to EV DC charging system according to claim 6, wherein the HMI is configured to receive one or more operator inputs including an amount of stored energy to be transferred from the source EV to the destination EV and a charge rate corresponding to a rate of transfer of the stored energy.

8. The EV to EV DC charging system according to claim 6, wherein the controller circuit is further configured to:
continuously monitor battery temperatures, voltage and isolation conditions; and
terminate the stored energy transfer between the source EV and the destination EV if a range of monitored conditions including the battery temperatures, the voltage and the isolation conditions exceed a predetermined value.

9. The EV to EV DC charging system according to claim 6, wherein the EVSE charger functions as at least one of an EVSE Vehicle to Load (V2L) charger, and an EVSE Vehicle to Grid (V2G) charger.

10. The EV to EV DC charging system according to claim 6, further comprising a DC-DC converter configured to adjust at least one of an output voltage, an output current, and an output power from the EVSE charger according to a request from the destination EV.
